(19) United States
(12) Patent Application Publication
(10) Pub. No.: US 2009/0316787 A1
(43) Pub. Date: Dec. 24, 2009

(54) MOVING IMAGE ENCODER AND DECODER, AND MOVING IMAGE ENCODING METHOD AND DECODING METHOD

(76) Inventors: Muneaki YAMAGUCHI, Inagi (JP); Masashi Takahashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/369,921

(22) Filed: Feb. 12, 2009

(30) Foreign Application Priority Data
Jun. 18, 2008 (JP) 2008-159446

(51) Int. Cl. H04N 7/32; H04N 7/34; H04N 7/50

(52) U.S. Cl. 375/240.16; 375/240.12; 375/E07.125

(57) ABSTRACT

A high-compression-ratio encoding and decoding technique is provided which enables random access image reproduction and which can prevent temporary decoding failure. A moving image encoder includes a substitute image generation section which generates a substitute image for a target area to be processed of an input image and a substitute image selection section which outputs information on the substitute image according to a reference image used at a prediction section. When the reference image used at the prediction section is an already encoded image, the substitute image selection section outputs the information on the substitute image to a variable-length encoding section. The variable-length encoding section encodes difference image data from a transform/quantization section into a variable-length code and generates an encoded stream by including the information on the substitute image in the variable-length code.

### CLAIM OF PRIORITY

The present application claims priority from Japanese patent application serial No. JP 2008-159446, filed on Jun. 18, 2008, the content of which is hereby incorporated by reference into this application.

### BACKGROUND OF THE INVENTION

(1) Field of the Invention

The present invention relates to an encoder, a decoder, an encoding method, and a decoding method for suitably encoding a moving image at a high compression ratio and suitably decoding the encoded moving image.

(2) Description of the Related Art

In related-art image encoding techniques, of which a representative one is MPEG-2, an input image ranging over a wide transmission band is made compatible with a narrow transmission band. This is made possible by making use of a general characteristic of image information, i.e. a characteristic in which there is a high degree of correlation between adjacent pixels and between pictures, and by removing redundant information such as high-frequency components, the variation of which is not easily perceivable by human beings.

In recent years, the H.264/AVC video compression standard worked out in a joint project by ISO/MPEG and ITU-T/VCEG has made it possible to achieve high coding efficiency, and the standard has been widely used. According to the H.264/AVC standard, image data is encoded in 16-by-16 pixel blocks referred to as macroblocks. For intra-picture or inter-picture prediction, each macroblock is divided into blocks of, for example, 16-by-16, 4-by-4, or 8-by-8 pixels, and each block is processed for prediction and encoding. This technique makes it possible to use different prediction modes according to minute motions or patterns in an input image, so that encoding efficiency can be improved.

Generally, inter-picture prediction can achieve higher accuracy than intra-picture prediction. Increasing the ratio of usage of inter-picture prediction can therefore lead to compression ratio improvement. In inter-picture prediction, however, a different picture (reference picture) than the picture being processed is used to generate a predicted image. Therefore, when a picture which has not been decoded is used as a reference picture, the resultant predicted image cannot be correctly decoded. Using a picture sequence headed by an I picture followed by P pictures composed using inter-picture prediction can achieve a highest compression ratio. A bit stream constructed in such a manner, however, cannot be reproduced from a halfway portion, that is, random-access reproduction cannot be performed. What is generally done to enable random-access reproduction in such a case is to periodically insert an I picture composed using intra-picture prediction only in the bit stream and thereby limit the range of pictures used for decoding, thereby limiting the range of pictures passed before required decoding is completed. In this way, random-access reproduction becomes possible, but normal reproduction does not start until the inserted I picture is decoded.

Encoding image data using inter-picture prediction may cause a problem in which decoding fails as a result of failure to obtain a required reference image. The problem is coped with by the following techniques.

The technique disclosed in JP-T-2007-535208 is aimed at preventing cases in which special reproduction is disrupted because of a failure to find a reference picture required for decoding in a relevant buffer. To achieve the aim, a stream generation device is used. The stream generation device generates a stream including an encoded picture and a command which is added to the encoded picture and which is used to control a buffer holding a decoded picture as a reference picture. The stream generation device has a determination unit and an addition unit. The determination unit determines whether an encoded picture attached with a command is skipped when special reproduction is performed. The addition unit attaches, when the determination unit determines that the encoded picture is skipped, the same repetition information as included in the command to another encoded picture which is decoded later than the above encoded picture and which is not skipped when special reproduction is performed.

The technique disclosed in JP-A-Hei9 (1997)-149421 is aimed at enabling, even when a picture is corrupted or missing in a bit stream being transmitted, P pictures to be decoded without waiting for a subsequent I picture. To achieve the aim, an image encoder is used which encodes an input image using a reference image and which transmits encoded data and a corresponding picture number to an image decoder. The image encoder includes a reference image update unit which controls updating of a reference image according to a decode result signal and the corresponding picture number received from the image decoder.

### SUMMARY OF THE INVENTION

An example case of decoding failure resulting from unavailability of a reference image used for inter-picture prediction will be described below.

FIGS. 6A and 6B schematically show decoding failure in inter-picture prediction. FIG. 6A shows inter-picture referencing. FIG. 6B shows an output image including blocks not successfully decoded. Each picture includes intra-predicted blocks and inter-predicted blocks.

Referring to FIGS. 6A and 6B, assume that reproduction (decoding) is started with picture 602 with an inter-predicted block 604 in picture 603 being required to be processed. When it is assumed that referencing for block 604 is made as shown by arrow 605 in FIG. 6A, a block 604 requires information on a picture 601 preceding a picture 602 with which decoding is started. Since the picture 601 has not been decoded, however, the block 604 cannot be correctly decoded. In cases where a picture to be outputted includes blocks which, like the block 604 described above, have not been correctly decoded, the resultant output image shows corrupted blocks 606 as shown in FIG. 6B.

As time elapses after decoding is started, decoding of reference blocks progresses, so that the number of blocks which fail to be decoded for display decreases. Still, it is unavoidable that, during a certain period of time after reproduction is started, the image displayed shows conspicuous corrupted blocks. The time required before a target block can be decoded depends on how far timewise the reference block to be referred to is from the target block, so that it is not necessarily constant. An image displayed with corrupted blocks as described above makes the viewer feel uncomfortable.

The technique disclosed in JP-T-2007-535208 referred to above only makes it possible to control a buffer holding reference pictures. The technique cannot make, using repetition information, a reference picture preceding a target picture to be decoded usable. Hence, decoding failure during a transient period is unavoidable.

In the technique disclosed in JP-A-Hei9 (1997)-149421 referred to above, a reference image is updated and encoded according to a decode result signal received from an image decoder. When the technique is used, therefore, temporary decoding failure is unavoidable. In addition, to perform a process which involves transmission and reception of a decode result signal, a system with a complicated configuration is required.

An object of the present invention is to provide a high-compression-ratio encoding and decoding technique which enables random access image reproduction and which can prevent temporary decoding failure.

The present invention provides a moving image encoder which generates a difference image between an input image and a corresponding predicted image and encodes the difference image. The moving image encoder includes: a prediction section which generates the predicted image using a reference image; a transform/quantization section which transforms and quantizes the difference image between the input image and the predicted image; a substitute image generation section which generates a substitute image for a target area to be processed of the input image; a substitute image selection section which outputs information on the substitute image according to the reference image used at the prediction section; and a variable-length encoding section which encodes the difference image data transformed and quantized at the transform/quantization section into a variable-length code and which generates an encoded stream by including the information on the substitute image outputted from the substitute image selection section in the variable-length code. In the moving image encoder, when the reference image used at the prediction section is an already encoded image, the substitute image selection section outputs the information on the substitute image to the variable-length encoding section.

The present invention also provides a moving image decoder which obtains a difference image by decoding an encoded input stream and generates a decoded image by adding a corresponding predicted image to the difference image. The moving image decoder includes: a variable-length decoding section which obtains difference image data, motion vector information, and information on a substitute image by variable-length-decoding the encoded input stream; an inverse transform/quantization section which inversely transforms and inversely quantizes the difference image data; a motion compensation section which generates the predicted image using the motion vector information and a lo reference image; a substitute image reconstruction section which reconstructs a substitute image for a target area to be processed based on the information on the substitute image; and an output image control section which outputs, according to the reference image used at the motion compensation section, one of an added image generated by adding the difference image from the inverse transform/quantization section to the predicted image from the motion compensation section and the substitute image reconstructed at the substitute image reconstruction section. In the moving image decoder, the output image control section outputs, when the reference image used at the motion compensation section has not been decoded, the reconstructed substitute image instead of the added image.

The present invention also provides a moving image encoding method for generating a difference image between an input image and a corresponding predicted image and encoding the difference image. The moving image encoding method includes: generating a substitute image for a target area to be processed of the input image; determining whether a reference image referred to in generating the predicted image is an already encoded image; and when it is determined that the reference image is an already encoded image, including information on the substitute image in an encoded stream of data for the target area to be processed.

The present invention also provides a moving image decoding method for obtaining a difference image by decoding an encoded input stream and generating a decoded image by adding a corresponding predicted image to the difference image. The moving image decoding method includes: obtaining information on a substitute image by decoding the encoded stream; reconstructing a substitute image for a target area to be processed based on the obtained information on the substitute image; determining whether a reference image referred to in generating the predicted image is an already decoded image; and when it is determined that the reference image is not an already decoded image, outputting the reconstructed substitute image instead of a decoded image for the target area to be processed.

According to the present invention, when random access reproduction is performed, the reproduced image shows no temporarily corrupted parts, so that the viewer is not caused to feel uncomfortable.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing the configuration of a moving image encoder according to an embodiment of the present invention (embodiment 1);

FIG. 2A shows, for comparison, a sequence of pictures encoded using an conventional technique and an example image reproduced from such encoded pictures;

FIG. 2B shows a sequence of pictures encoded according to the present embodiment and an example image reproduced from such encoded pictures;

FIG. 3 is a flowchart showing an encoding process according to the present embodiment;

FIG. 4 is a diagram for explaining an example of generation of substitute image information according to the present embodiment;

FIG. 5 is a diagram showing an example structure of an encoded bit stream;

FIGS. 6A and 6B schematically show decoding failure in inter-picture prediction;

FIG. 7 is a diagram showing the configuration of a moving image decoder according to an embodiment of the present invention (embodiment 2); and

FIG. 8 is a flowchart showing a decoding process according to the present embodiment.

### DETAILED DESCRIPTION OF THE EMBODIMENTS

An embodiment of a moving image encoder and an embodiment of a moving image decoder according to the present invention will be described below.

### Embodiment 1

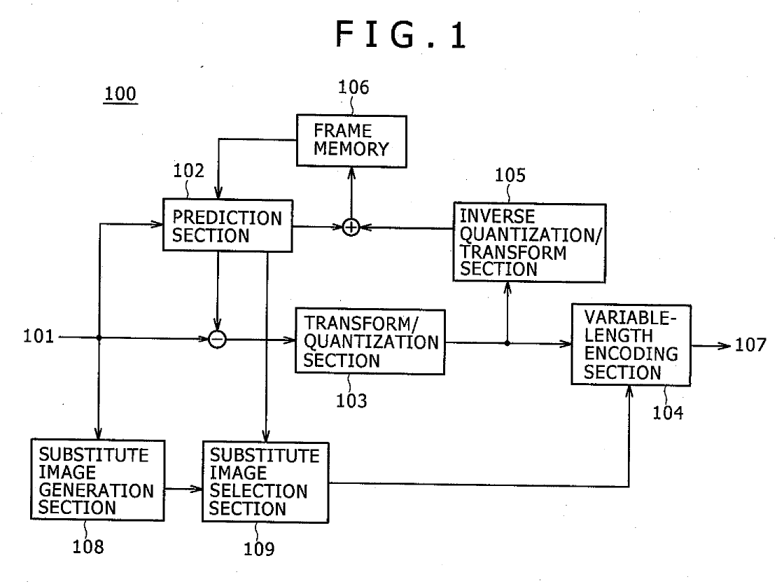

FIG. 1 is a diagram showing the configuration of a moving image encoder according to an embodiment of the present invention. A moving image encoder 100 of the present embodiment includes such processing modules as a prediction section 102, a transform/quantization section 103, a variable-length encoding section 104, an inverse quantization/transform section 105, a frame memory 106, a substitute image generation section 108, and a substitute image selection section 109.

When an input moving image 101 is inputted, the prediction section 102, referring to the frame memory 106, generates a predicted image and performs motion vector estimation. A difference image between the input image and the predicted image is obtained. The difference image is sent to the transform/quantization section 103 where it is subjected to discrete cosine transform (DCT) and quantization. After being processed at the transform/quantization section 103, the difference image is encoded at the variable-length encoding section 104 to be then outputted as an encoded bit stream 107. The bit stream 107 contains information of a motion vector (motion vector information), not shown. The data transformed and quantized at the transform/quantization section 103 is also added, after being inverse-quantized and inverse-transformed at the inverse quantization/transform section 105, to the predicted image and then stored in the frame memory 106 to be used for image prediction in the next stage.

When predicting an image, the prediction section 102 determines whether to perform prediction within the picture being processed (intra-picture prediction) or prediction using an already encoded picture (inter-picture prediction) and communicates the result of determination to the substitute image selection section 109.

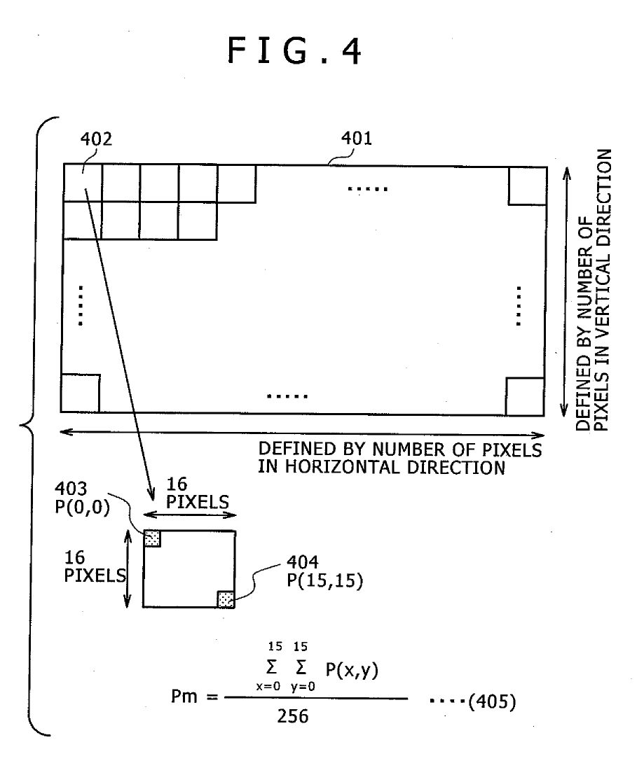

The substitute image generation section 108 generates a substitute image using the input image 101. The substitute image represents a representative pixel value, for example, an average pixel value, in a target image area being processed. For example, an average pixel value Pm of the pixels of an input image is calculated and the calculated average pixel value Pm is inputted to the substitute image selection section 109 as information on the substitute image (substitute image information). How to calculate the average pixel value Pm will be explained in detail later with reference to FIG. 4.

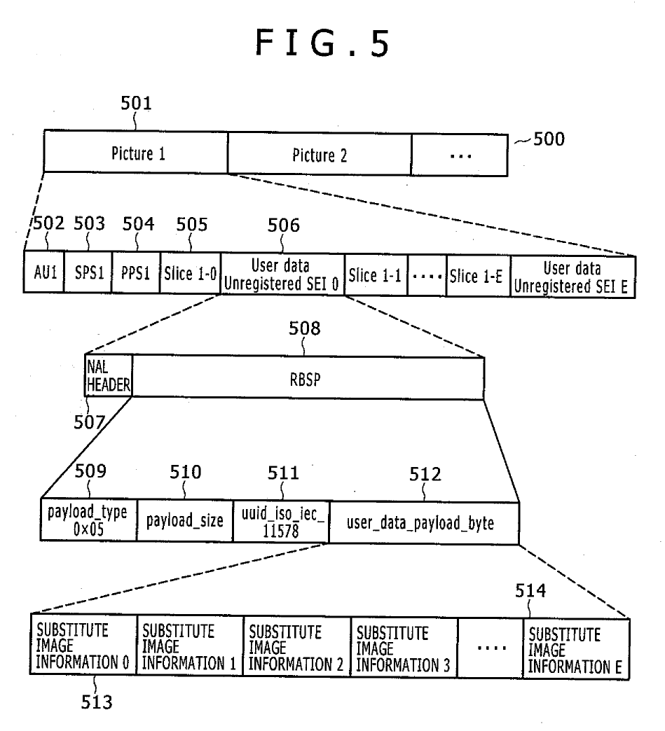

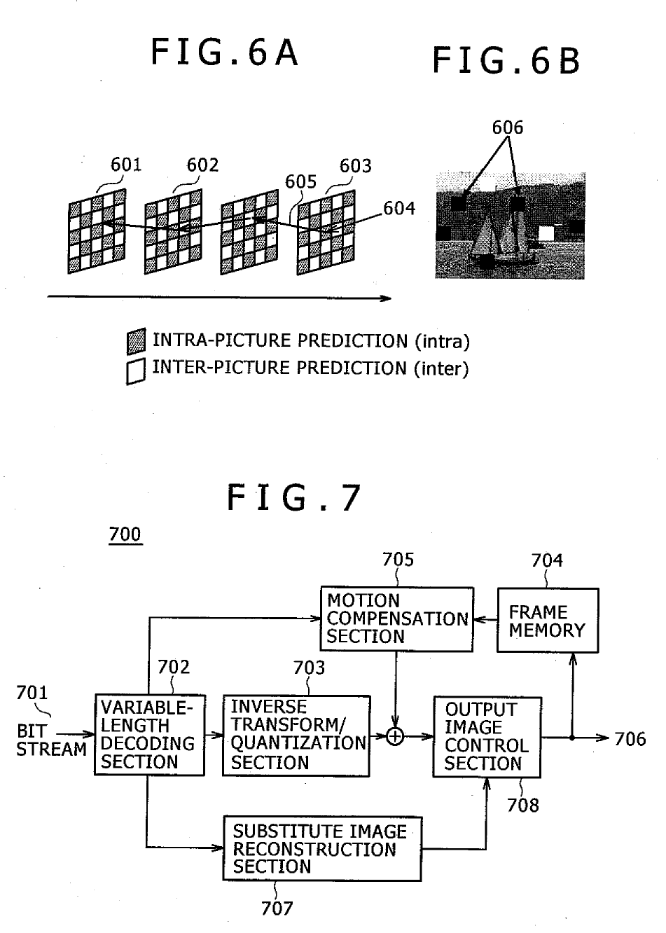

Only when predicting an image using an already encoded picture (inter-picture prediction) according to the information (on whether to perform intra-picture prediction or inter-picture prediction) obtained from the prediction section 102, the substitute image selection section 109 outputs the information on the substitute image (the substitute image information) received from the substitute image generation section 108 to the variable-length encoding section 104. The variable-length encoding section 104 includes the substitute image information in the encoded bit stream 107 and outputs the bit stream. The structure of the bit stream 107 will be described later with reference to FIG. 5.

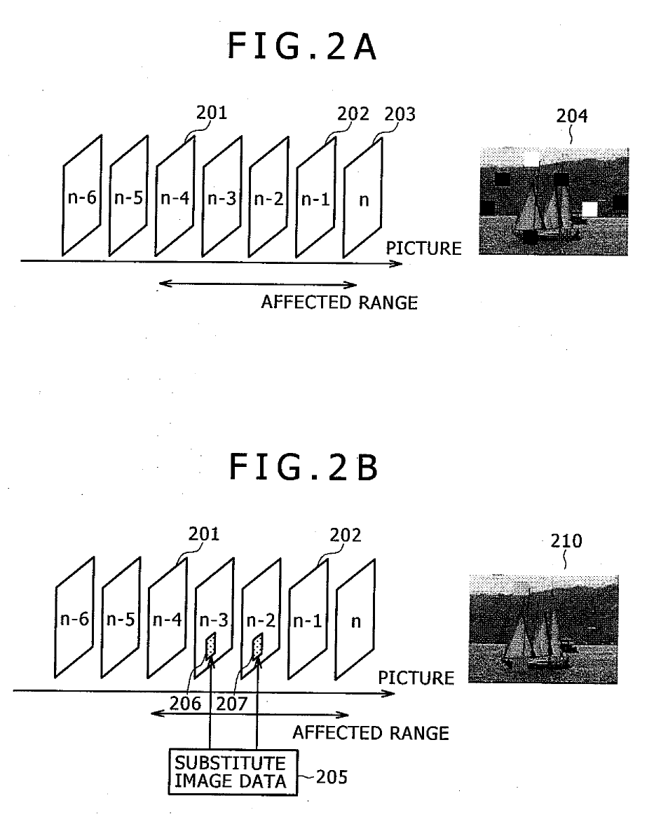

FIGS. 2A and 2B are diagrams for explaining image quality improvement realized by a substitute image according to the present embodiment. FIG. 2A shows, for comparison, a sequence of pictures encoded using an conventional technique and an example image reproduced from such encoded pictures. FIG. 2B shows a sequence of pictures encoded according to the present embodiment and an example image reproduced from such encoded pictures.

Referring to FIG. 2A showing pictures encoded using an conventional technique, the images of pictures outputted during a predetermined period, which is dependent on a time requirement related with picture referencing and which starts from a reproduction starting picture 201, include conspicuous corrupted blocks. Namely, whereas the images of the pictures beginning with a picture 203 outputted after the predetermined period do not show such corrupted blocks, the images of the earlier pictures ranging from the picture 201 to a picture 202 show, like an example image 204, conspicuous corrupted blocks.

In the present embodiment as illustrated in FIG. 2B, on the other hand, image areas referring to earlier images for image prediction (inter-picture prediction areas) are provided with auxiliary data having pixel values representative of the image areas, and substitute images are generated using the auxiliary data. As a result, corrupted blocks of the images of pictures including such image areas become inconspicuous. Namely, substitute image data 205 is prepared and substituted for decoded image data in areas 206 and 207 which will, if displayed as they are, show as conspicuous corrupted blocks. In this way, the pictures 201 through 202 outputted during the period in which reproduction is affected by the time required for picture referencing can also present images, like an example output image 210, in which corrupted blocks are inconspicuous.

As described above, in the present embodiment, the picture that was referred to when a picture being processed was encoded is analyzed, and substitute image data is lo prepared for image areas which may show as corrupted blocks when decoded. The substitute image data is included as auxiliary data in the encoded image data to be transmitted. This makes it possible to display images free of corrupted blocks even during a period immediately after a start of random access reproduction. Such substitute image data is transmitted as additional auxiliary data and is small in data volume. It does not cause a problem in terms of compatibility with image data decoding performed using an conventional technique.

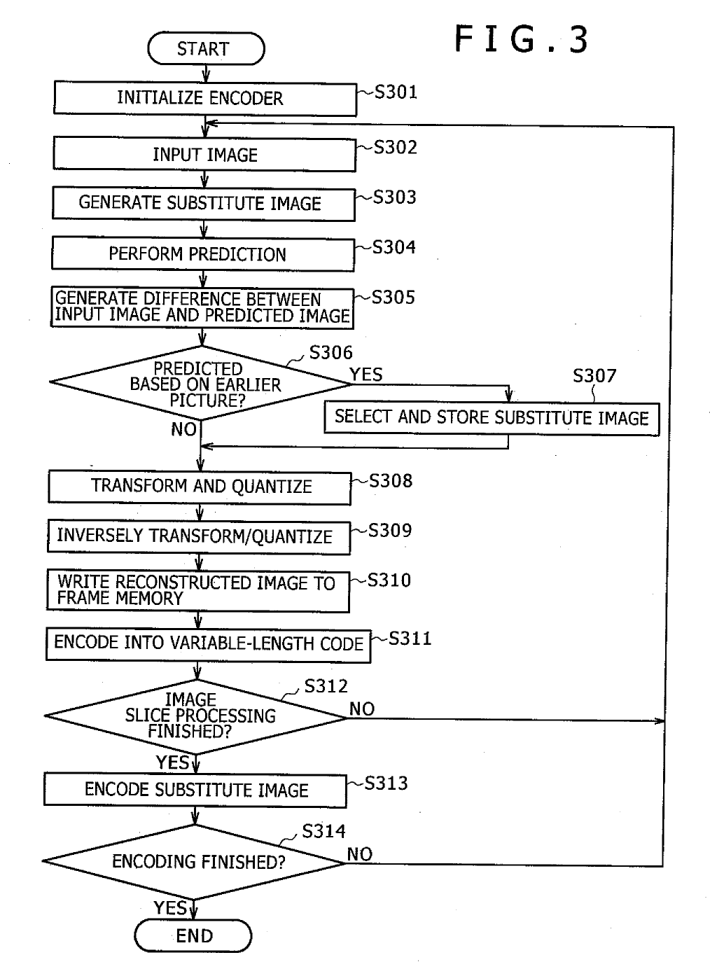

FIG. 3 is a flowchart showing an encoding process according to the present embodiment. Each step of the process will be described below.

In step S301, the encoder is initialized. In step S302, a moving image is inputted. In step S303, the substitute image generation section 108 generates substitute image information. In step S304, the prediction section 102 sets a prediction target area and performs image prediction. In step S305, the difference value between the input image and the predicted image is calculated.

In step S306, which of intra-picture prediction and inter-picture prediction was performed in step S304 is determined. Only when it is determined that prediction based on an earlier encoded image (inter-picture prediction) was performed in step S304, the procedure advances to step S307 where the substitute image generated in step S303 is selected and stored in a buffer. In step S308, the transform/quantization section 103 transforms and quantizes the difference value converting the difference value into transformed and quantized data. In step S309, the transformed and quantized data is inversely transformed and inversely quantized, and the resultant data and the predicted value are added. The data obtained as a result of the addition is written, as a reconstructed image, into the frame memory 106 in step S310. In step S311, the variable-length encoding section 104 encodes the data transformed and quantized in step S308 into variable-length codes and outputs the codes as a bit stream.

In step S312, whether processing of a slice of image has been finished is determined. When it is determined that processing of a slice of image has not been finished, the procedure returns to step S302 to repeat the subsequent steps. When processing of a slice of image is finished, the procedure advances to step S313 where the substitute image stored in the buffer in step S307 is encoded and included, as substitute image information, in the bit stream. In step S314, whether the encoding process has been finished is determined. When it is determined that the encoding process has not been finished, the procedure returns to step S302 to repeat the subsequent steps.

FIG. 4 is a diagram for explaining an example of generation of substitute image information (in step S303) according to the present embodiment.

In image encoding based on the H.264 standard, for example, a picture 401 is divided into macroblocks 402 of 16-by-16 pixels each, and the macroblocks are individually processed. It is, therefore, appropriate to generate substitute images in units of macroblocks. Relationship between a picture and macroblocks are illustrated in FIG. 4. In cases where a substitute image for a 16-by-16 pixel macroblock is generated using an average pixel value in the macroblock, substitute image information Pm can be generated by adding up all pixel data (including brightness values and color-difference information) in the macroblock measuring 16 pixels each horizontally (x direction) and vertically (y direction) and dividing the added-up value by 256, i.e. the number of pixels of the macroblock. To be concrete, when a pixel 403 in the upper left corner of the macroblock is defined as P(0, 0) and a pixel 404 in the lower right corner of the macroblock is defined as P(15, 15), the substitute image information Pm is calculated using an equation 405 shown in FIG. 4. The substitute image information Pm thus calculated is included in the bit stream and the bit stream is outputted. The substitute image information Pm gives a representative pixel value of the macroblock. Since the number of bits required for the substitute image information Pm is very small, including the substitute image information Pm in the bit stream does not virtually affect the bit stream transmission.

Even though, in the present embodiment, the average pixel value in the macroblock being processed is used for a substitute image, a different method can also be used. For example, a macroblock may be divided into units of 8-by-8 pixels, and a value obtained by subjecting the 8-by-8 pixel units to DCT processing and quantization may be used for a substitute image. Also, in the present embodiment, a substitute image is generated using a pixel value obtained from a target image area, it may be generated based on a reference image area.

FIG. 5 is a diagram showing an example structure of an encoded bit stream (step S313). The bit stream structure being described complies with the H.264 standard. In the bit stream structure, substitute image information is included in a user data area referred to as “user data unregistered SEI message.” A bit stream 500 is encoded in units each referred to as a picture 501. Each picture 501 includes an access unit delimiter (AU) 502, a sequence parameter set (SPS) 503, a picture parameter set (PPS) 504, and slices 505. Each of the slices 505 is followed by a user data unregistered SEI message 506, and substitute image information is included in the user data unregistered SEI message 506.

Each user data unregistered SEI message 506 includes a NAL header 507 and a raw byte sequence payload (RBSP) 508. The RBSP 508 includes a payload_type (509), a payload_size (510), a uuid_iso_iec_{—}11578 (511), and a user_data_payload_byte (512). Substitute image information 513 to 514 is included in the user_data_payload_byte (512). Substitute image information is fixed-length information. For each image slice, substitute image information prepared for each of the corresponding macroblocks is included in the bit stream. As both the encoder and decoder can determine the number of the corresponding macroblocks, other information does not necessarily have to be included in the user_data_payload_byte (512). Since the user_data_payload_byte (512) is a user data area, including substitute image information in the area does not affect decoding processing performed by an conventional method. Hence, no compatibility problem is caused.

### Embodiment 2

FIG. 7 is a diagram showing the configuration of a moving image decoder according to an embodiment of the present invention. A moving image decoder 700 of the present embodiment includes such processing modules as a variable-length decoding section 702, an inverse transform/quantization section 703, a frame memory 704, a motion compensation section 705, a substitute image reconstruction section 707, and an output image control section 708.

When a bit stream 701 is inputted, it is subjected to variable-length decoding processing at the variable-length decoding section 702. As a result, difference image data, information on a motion vector (motion vector information), and information on a substitute image (substitute image information) are obtained. The difference image data is sent to the inverse transform/quantization section 703. The motion vector information is sent to the motion compensation section 705. The substitute image information is sent to the substitute image reconstruction section 707. At the inverse transform/quantization section 703, the difference image data is inversely transformed and inversely quantized using transform coefficients and quantization parameters, and a difference image is obtained. At the motion compensation section 705, a predicted image is generated using a motion vector and a reference image stored in the frame memory 704. The predicted image and the difference image are added to generate an added image. The added image is sent to the output image control section 708. At the substitute image reconstruction section 707, a substitute image is reconstructed based on the input substitute image information. The reconstructed substitute image is sent to the output image control section 708.

At the output image control section 708, whether the added image generated by adding the predicted image and the difference image is usable is determined. Namely, it is determined whether the predicted image generated at the motion compensation section 705 is usable and whether it can be completely predicted using an image already decoded in the moving image decoder 700. For example, the reference image referred to in generating the predicted image is determined, and whether the reference image is among the images already decoded is determined. When it is determined that the reference image has been decoded, the added image is stored as it is in the frame memory 704 and, at the same time, it is outputted as a decoded image. When it is determined that the reference image has not been decoded, the substitute image generated at the substitute image reconstruction section 707 is stored in the frame memory 704 instead of the added image, and the substitute image is outputted as a decoded image.

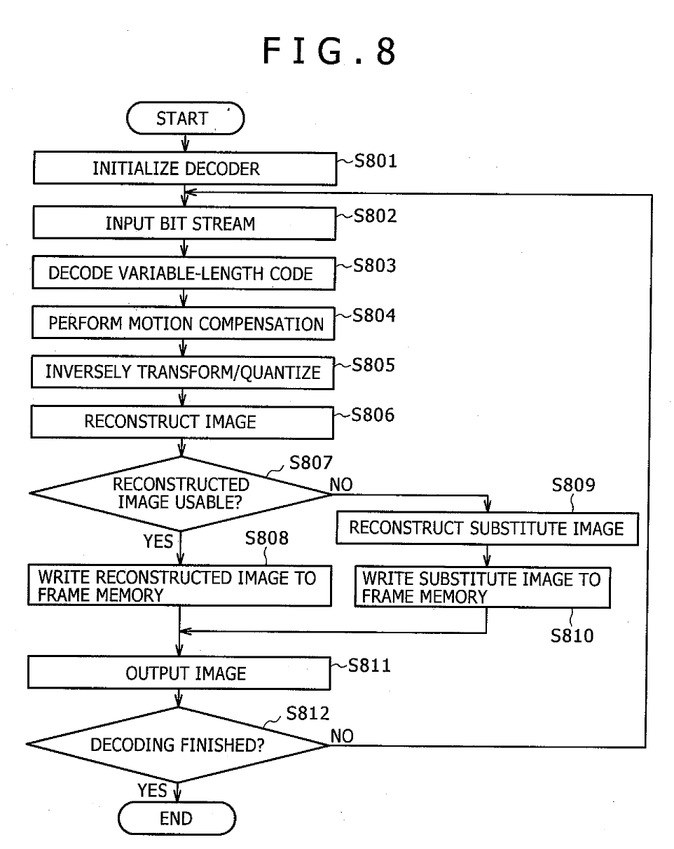

FIG. 8 is a flowchart showing a decoding process according to the present embodiment. Each step of the process will be described below.

In step S801, the decoder is initialized. In step S802, a bit stream is inputted. In step S803, the variable-length decoding section 702 performs variable-length decoding. In step S804, a predicted image is generated by performing motion compensation processing based on decoded information. In step S805, a difference image is generated by performing inverse transform and inverse quantization. In step S806, an added image is reconstructed by adding the predicted image and the difference image.

In step S807, the output image control section 708 determines whether the reconstructed image is usable. The determination is made by checking whether the reference image referred to in generating the predicted image is among the images already decoded. When the reconstructed image is determined usable, it is written to the frame memory 704 in step S808. When the reconstructed image is determined not usable, a substitute image is reconstructed in step S809 based on decoded information. The substitute image is written to the frame memory 704 in step S810. In step S811, the image written to the frame memory 704 is outputted as a decoded image. In step S812, whether the decoding process has been finished is determined. When it is determined that the decoding process has not been finished, the procedure returns to step S802 to repeat the subsequent steps.

As described above, in the present embodiment, whether a predicted image is usable is determined by analyzing, during the decoding process, the reference image referred to in generating the predicted image. When the predicted image is determined not usable, a substitute image is outputted. Since the substitute image is one generated using a representative pixel value of the image area involved, image defects in the image area can be made inconspicuous. In this way, image defects can be prevented from showing when random-access reproduction is performed. As a result, the viewer of the reproduction is prevented from feeling uncomfortable.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A moving image encoder which generates a difference image between an input image and a corresponding predicted image and encodes the difference image, the encoder comprising:
a prediction section which generates the predicted image using a reference image;
a transform/quantization section which transforms and quantizes the difference image between the input image and the predicted image;
a substitute image generation section which generates a substitute image for a target area to be processed of the input image;
a substitute image selection section which outputs information on the substitute image according to the reference image used at the prediction section; and
a variable-length encoding section which encodes the difference image data transformed and quantized at the transform/quantization section into a variable-length code and which generates an encoded stream by including the information on the substitute image outputted from the substitute image selection section in the variable-length code;
wherein when the reference image used at the prediction section is an already encoded image, the substitute image selection section outputs the information on the substitute image to the variable-length encoding section.

2. The moving image encoder according to claim 1, wherein the substitute image generation section generates the substitute image using an average pixel value in the target area to be processed.

3. The moving image encoder according to claim 1, wherein the variable-length encoding section includes the information on the substitute image in a user data area of the encoded stream.

4. A moving image decoder which obtains a difference image by decoding an encoded input stream and generates a decoded image by adding a corresponding predicted image to the difference image, the decoder comprising:
a variable-length decoding section which obtains difference image data, motion vector information, and information on a substitute image by variable-length-decoding the encoded input stream;
an inverse transform/quantization section which inversely transforms and inversely quantizes the difference image data;
a motion compensation section which generates the predicted image using the motion vector information and a reference image;
a substitute image reconstruction section which reconstructs a substitute image for a target area to be processed based on the information on the substitute image; and
an output image control section which outputs, according to the reference image used at the motion compensation section, one of an added image generated by adding the difference image from the inverse transform/quantization section to the predicted image from the motion compensation section and the substitute image reconstructed at the substitute image reconstruction section;
wherein the output image control section outputs, when the reference image used at the motion compensation section has not been decoded, the reconstructed substitute image instead of the added image.

5. The moving image decoder according to claim 4, wherein the substitute image reconstruction section reconstructs the substitute image using an average pixel value in the target area to be processed.

6. A moving image encoding method for generating a difference image between an input image and a corresponding predicted image and encoding the difference image, the method comprising:
generating a substitute image for a target area to be processed of the input image;
determining whether a reference image referred to in generating the predicted image is an already encoded image; and
when it is determined that the reference image is an already encoded image, including information on the substitute image in an encoded stream of data for the target area to be processed.

7. The moving image encoding method according to claim 6, wherein the substitute image is generated using an average pixel value in the target area to be processed.

8. The moving image encoding method according to claim 6, wherein the information on the substitute image is included in a user data area of the encoded stream.

9. A moving image decoding method for obtaining a difference image by decoding an encoded input stream and generating a decoded image by adding a corresponding predicted image to the difference image, the method comprising:
obtaining information on a substitute image by decoding the encoded stream;
reconstructing a substitute image for a target area to be processed based on the obtained information on the substitute image;
determining whether a reference image referred to in generating the predicted image is an already decoded image; and
when it is determined that the reference image is not an already decoded image, outputting the reconstructed substitute image instead of a decoded image for the target area to be processed.

10. The moving image decoding method according to claim 9, wherein the substitute image is reconstructed from an average pixel value in the target area to be processed.
